(19) United States
(12) Patent Application Publication
(10) Pub. No.: US 2014/0197646 A1
(43) Pub. Date: Jul. 17, 2014

(54) CAMMING DOG

(71) Applicant: POMPANETTE, LLC, Charlestown, NH (US)

(72) Inventor: James H. Kyle, Alstead, NH (US)

(73) Assignee: POMPANETTE, LLC, Charlestown, NH (US)

(21) Appl. No.: 13/741,698

(22) Filed: Jan. 15, 2013

(51) Int. Cl. E05C 3/14

(52) U.S. Cl. CPC E05C 3/14
USPC 292/241

(57) ABSTRACT

A camming dog configured for use with a window having a frame and a hinged lens. The camming dog includes an angled base having a base mounting portion and a handle mounting portion, wherein the base mounting portion is secured to the frame, the base mounting portion is disposed at an angle relative to the handle mounting portion, the angle is less than ninety degrees. The camming dog further includes a handle having an arm boss, wherein the handle is rotationally secured to the handle mounting portion of the angled base and rotates about an axis of rotation. Upon rotation of the handle to an open position, the hinged lens rotates unimpeded past the arm boss and upon rotation of the handle to a closed position, the hinged lens is secured within the frame by the arm boss.

### FIELD OF THE INVENTION

The invention broadly relates to locking devices, more particularly to locking devices used on port assemblies on marine vessels, and even more particularly to a camming dog locking device used on port assemblies on marine vessels.

### BACKGROUND OF THE INVENTION

Portlights make it possible for fresh air and light to pass into the interior of a marine vessel, thereby creating a more enjoyable environment. A variety of dogging mechanisms used in combination with one or more gaskets have been employed in port assemblies to ensure that the assemblies are sealed from environmental ingress, e.g., water, salt, cold air, etc., when the assemblies are in closed positions.

Rotating lever dogs, such as those shown in U.S. Pat. No. 5,842,433, are rather simple in design. The operator pushes the lens closed and against a gasket with one hand while rotating the lever from a parked position to a locking position. The parked position is typically parallel to the frame and outside of the clear aperture of the lens. There may be a small ramping slope on the bottom of the lever to engage the lens early in the rotation as this arrangement generates a small downward or inward force as the lever swings to the final locking position, typically perpendicular to the frame and within the viewing area. The dog may have a set screw adjustment to allow for micro adjustment of the engaging surface of the lever. Such adjustment permits an operator to ensure that the lens is properly compressed against the gasket thereby forming a complete seal about the perimeter of the lens.

However, rotating lever dogs require the operator to exert a considerable amount of effort, i.e., force, in order to sufficiently close the portlight. By design, the lens must be below the lever in order for the lever to rotate over the lens. A typical lever is about 2 inches long and will engage or begin to engage the lens after rotating only about 10 degrees. The initial contact point of the lever, therefore, is about 1.5 inches out on the lever as measured from the point of rotation of the lever. If the contact point is positioned closer to the point of rotation, e.g., ½ inch away from the point of rotation, the lever would exert a downward force three times (3×) greater than when the contact point positioned at 1.5 inches from the point of rotation. When pressure is applied to the lens, the lever is forced upward or outward. Thus, the stiffness of the lever is important as the lever must be sufficiently strong to not yield to the upward or outward pressure. Moreover, the force may resolve itself on the vertical shaft aligned with the axis of rotation, which is tall and narrow. These shafts may also deflect under the pressure.

Screw dogs, such as screw dog 10 shown in FIG. 1, are very strong. They require some part of lens 12 or lens frame 14 to reach over dog base 16, which arrangement can present some design issues. The knob included in a screw dog, e.g., knob 18, can take considerable time to unscrew. Moreover, screw dogs are expensive to manufacture and are somewhat awkward to use because after the dog is unscrewed far enough to allow the dog to swing clear of the attachment point, e.g., attachment point 20, the knob and its swing bolt, e.g., swing bolt 22, have to be manually rotated out of the way of the lens. One of ordinary skill in the art will appreciate that there are many hand operations required to open and close a portlight having a screw dog. In addition, some larger portlights have dogs mounted not just on the bottom of the portlight, but vertically on the sides and also along the top of the lens. Screw dogs have to be held in an outboard position by friction or mechanical means or the lens can not swing clear past the screw dogs. This renders the screw dog unusable in some circumstances. The thickness of the hull or deck and the size of the knobs have a great effect on the length of the dog assembly. For example, the thicker the hull the more restricted the outboard swing of the dog; hence, a longer dog bolt must be used to allow the lens to clear the knob. The entire assembly then grows in size creating more problems with the amount the dog projects above the surface of the lens and the time to unscrew the dogs. Screw dogs do not easily fit on the narrow edge of the portlight frame, which is a critical characteristic in many dog designs.

Snap dogs, such as snap dog 30 shown in FIG. 2, engage edge 32 of lens 34 or a receiver (not shown) mounted on edge 32 of lens 34 and may come in a variety of configurations. Because the pivot of the dog is outboard of the contact area, the way the dog works is that dog 30 engages edge 32 of lens 34 while it is still slightly open and then, as dog 30 is pushed down, the contact area passes through and below reaction line 36 between the edge of lens 34 and hinge pin 38 of dog 30.

To operate a snap dog, the portlight must first be mechanically deflected to allow contact area 40 to pass through the straight line between the lens hinge pin (not shown) and dog pin 38, i.e., pass through reaction line 36. Not only does this arrangement make for a weak dog and a portlight that deflects when dogged down, it also requires a tremendous amount of force to disengage the dog, and therefore imposes pretty tight tolerances on the lens/dog mechanical layout.

A typical camming dog provides a strong, fool proof, adjustable design that does not block the viewing area or clear aperture of the lens when engaged, and can fit on a thin edge of a portlight frame. The above described prior art designs each have deficiencies with respect to at least one of the foregoing desirable characteristics.

As can be derived from the variety of devices and methods directed at providing a dog mechanism, many means have been contemplated to accomplish the desired end, i.e., one-handed operation of a compact, strong device for opening and closing a portlight. Heretofore, tradeoffs between strength, ease of use and physical arrangement of components were required. Thus, there is a long-felt need for a compact camming dog that can easily be operated with one hand.

### BRIEF SUMMARY OF THE INVENTION

The present invention comprises a camming dog configured for use with a window having a frame and a hinged lens. The camming dog includes an angled base having a base mounting portion and a handle mounting portion, wherein the base mounting portion is secured to the frame, the base mounting portion is disposed at an angle relative to the handle mounting portion, the angle is less than ninety degrees. The camming dog further includes a handle having an arm boss, wherein the handle is rotationally secured to the handle mounting portion of the angled base and rotates about an axis of rotation. Upon rotation of the handle to an open position, the hinged lens rotates unimpeded past the arm boss and upon rotation of the handle to a closed position, the hinged lens is secured within the frame by the arm boss.

In some embodiments, the window is a port for a marine vessel. In some embodiments, the port is an inwardly opening port and the camming dog is disposed on an inner surface of a wall of the marine vessel. In some embodiments, the window further includes a gasket disposed between the frame and the lens, and the lens compressively seals against the gasket when the handle is in the closed position. In some embodiments, the angle ranges from about 60 to about 70 degrees. In some embodiments, the handle is rotatably secured to the angled base by a fastener. In some embodiments, the arm boss contacts the lens at a contact point and the contact point is offset from the axis of rotation. In some embodiments, the handle further includes a mechanical stop configured to prevent further rotation of the handle when arranged in the closed position. In some embodiments, a position of the arm boss relative to the lens is altered by modifying the angle. In some embodiments, a position of the arm boss relative to the lens is altered by modifying a position of the axis of rotation relative to the handle mounting portion. In some embodiments, the handle rotates in a plane substantially parallel to the handle mounting portion.

In some embodiments, the handle rotates through approximately one hundred eighty degrees, where the handle is in a closed position at zero degrees, a partially open position at ninety degrees and an open position at one hundred eighty degrees. In some of those embodiments, the arm boss is adjacent to the lens when the handle reaches the partially open position as the handle is rotated from the open position to the closed position. Moreover, in some of those embodiments, rotating the handle from the partially open position to the closed position causes the arm boss to engage the lens and subsequently secure the lens within the frame. Still yet further, in some of those embodiments, the window further includes a gasket disposed between the frame and the lens, and rotating the handle from the partially open position to the closed position compresses the lens against the gasket.

In some embodiments, the camming dog further includes an alignment guide fixedly secured to the handle mounting portion and a height adjustment sleeve having an opening offset from a center position on the height adjustment sleeve, the opening complimentarily engaging the alignment guide. In those embodiments, the handle is rotationally secured to the handle mounting portion by the height adjustment sleeve and rotating a position of the height adjustment sleeve relative to the alignment guide alters the position of the handle relative the handle mounting portion.

The present invention comprises a height adjusting apparatus for a camming dog, wherein the camming dog includes an angled base having a base mounting portion and a handle mounting portion, wherein the base mounting portion is secured to the frame, the base mounting portion is disposed at an angle relative to the handle mounting portion, the angle is less than ninety degrees, and a handle having an arm boss, wherein the handle is rotationally secured to the handle mounting portion of the angled base and rotates about an axis of rotation. Upon rotation of the handle to an open position, the hinged lens rotates unimpeded past the arm boss and upon rotation of the handle to a closed position, the hinged lens is secured within the frame by the arm boss. The height adjusting apparatus includes an alignment guide fixedly secured to the handle mounting portion and a height adjustment sleeve having an opening offset from a center position on the height adjustment sleeve, the opening complimentarily engaging the alignment guide. The handle is rotationally secured to the handle mounting portion by the height adjustment sleeve and rotating a position of the height adjustment sleeve relative to the alignment guide alters the position of the handle relative the handle mounting portion.

An object of the invention is to provide a locking dog that does not project into the clear viewing area, as defined by the aperture you can see through that is covered by the lens, whether the lens is surrounded by a frame or is merely an unframed lens such as a piece of acrylic.

Another object of the invention is to provide a locking dog that attaches to the frame of the port and permit the interior trim ring to slide past allowing for various thicknesses of hull or deck structure. Thus, in many cases, based on the port design, the interior frame ends up well above the portlight frame.

Yet another object of the invention is that the locking dog is fast acting.

Still yet another object of the invention is to provide a locking dog that is absolutely positive, self-parking, and cannot vibrate open accidentally.

It is a further object of the invention to provide a locking dog that permits one handed operation thereby avoiding the typical arrangement of the operator pushing against the lens of a portlight to push it down onto the gasket, slightly compressing the gasket, so that the dog mechanism can engage the lens.

Another object of the invention is to provide a locking dog which is small and compact because portlights are often mounted in a deck at eye height and the projecting dog can cause serious injury should a person fall against it.

Yet another object of the invention is to provide a locking dog having a self parking position when the dog is disengaged thereby eliminating levers and swing bolts which fall down and flop around unless constrained in some manner.

Still yet another object of the invention is to provide a locking dog having vertical adjustment to compensate for permanent gasket compression that occurs over time.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a side elevational view of a prior art swing dog;

FIG. 2 is a side elevational view of a prior art snap dog;

FIG. 3 is a perspective view of an embodiment of a present invention camming dog;

FIG. 4 is a side elevational view of an embodiment of a present invention camming dog in a closed position;

FIG. 5 is a front elevational view of an embodiment of a present invention camming dog in a closed position;

FIG. 6 is a side elevational view of an embodiment of a present invention camming dog in a partially closed position;

FIG. 7 is a front elevational view of an embodiment of a present invention camming dog in a partially closed position;

FIG. 8 is a side elevational view of an embodiment of a present invention camming dog in an open position;

FIG. 9 is a front elevational view of an embodiment of a present invention camming dog in an open position;

FIG. 10 is a front perspective view of another embodiment of a present invention camming dog;

FIG. 11 is a back perspective view of the camming dog shown in FIG. 10;

FIG. 12 is a front elevational view of the camming dog shown in FIG. 10;

FIG. 13 is a cross-sectional view of the camming dog shown in FIG. 10 taken generally along Line 13-13 of FIG. 12 and,

FIG. 14 is a back elevational view of an embodiment of a height adjusting sleeve.

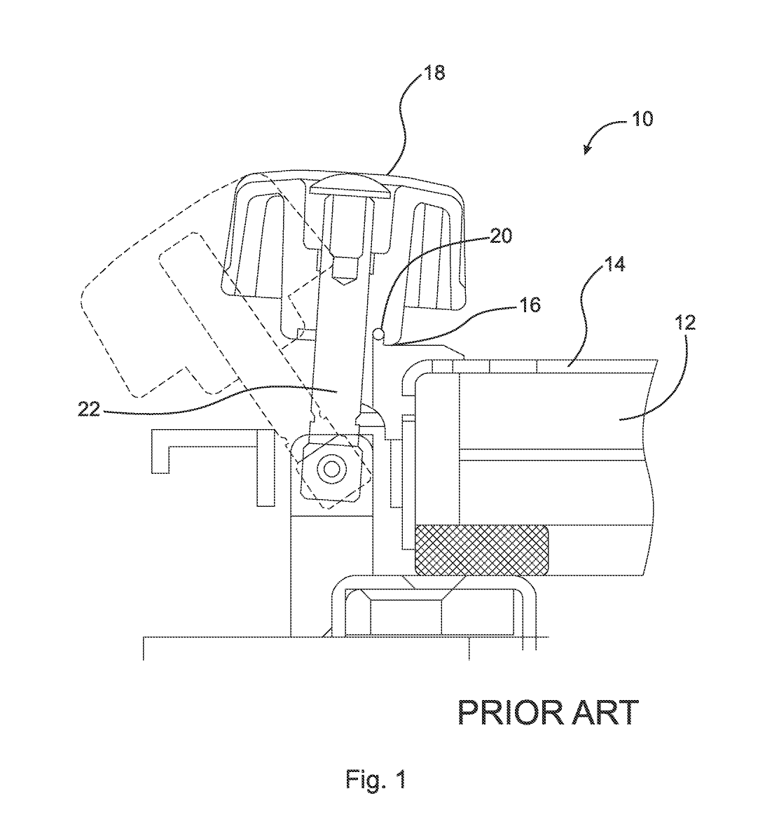

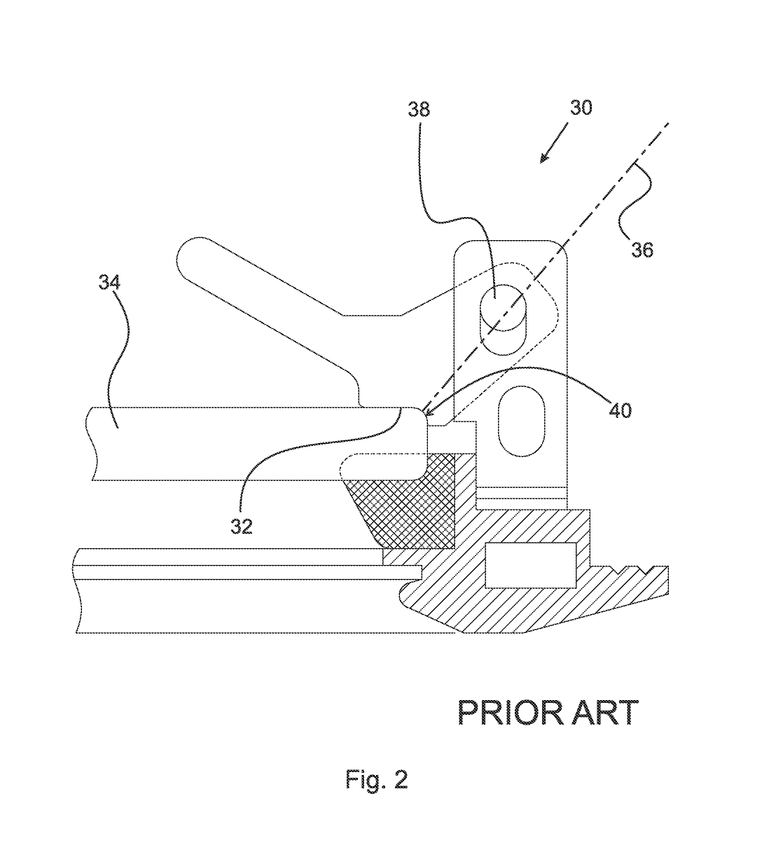

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Unless defined otherwise, all technical and scientific terms used herein have the same meaning as commonly understood to one of ordinary skill in the art to which these embodiments belong. As used herein, “dog” is intended to be broadly construed as a mechanical device for holding a port, window, lens, hatch or other closing in a closed and secured position.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

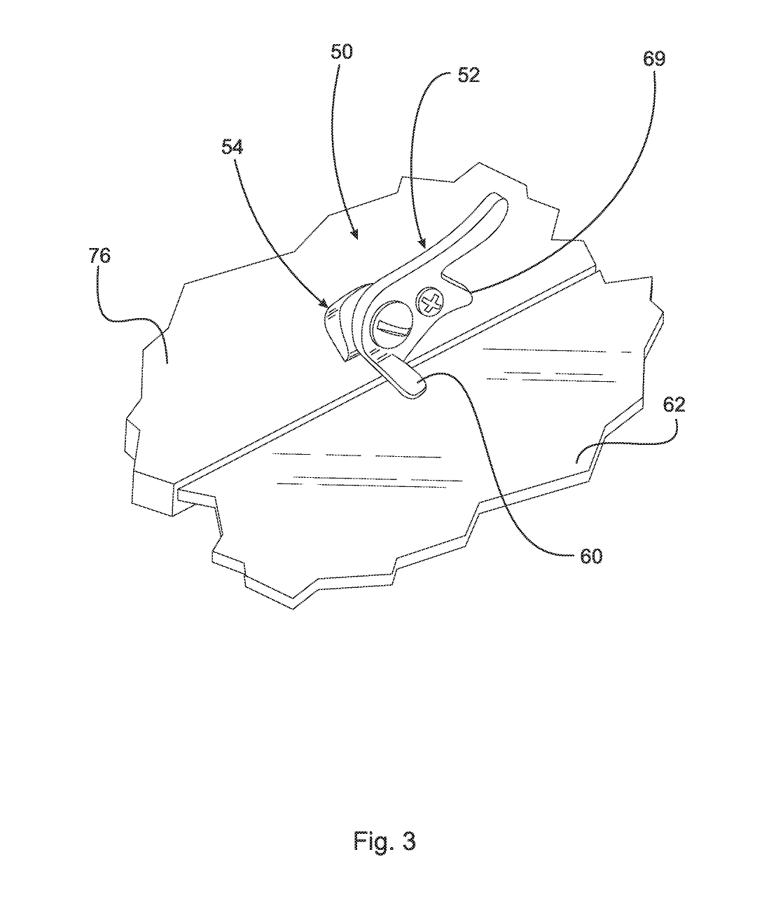

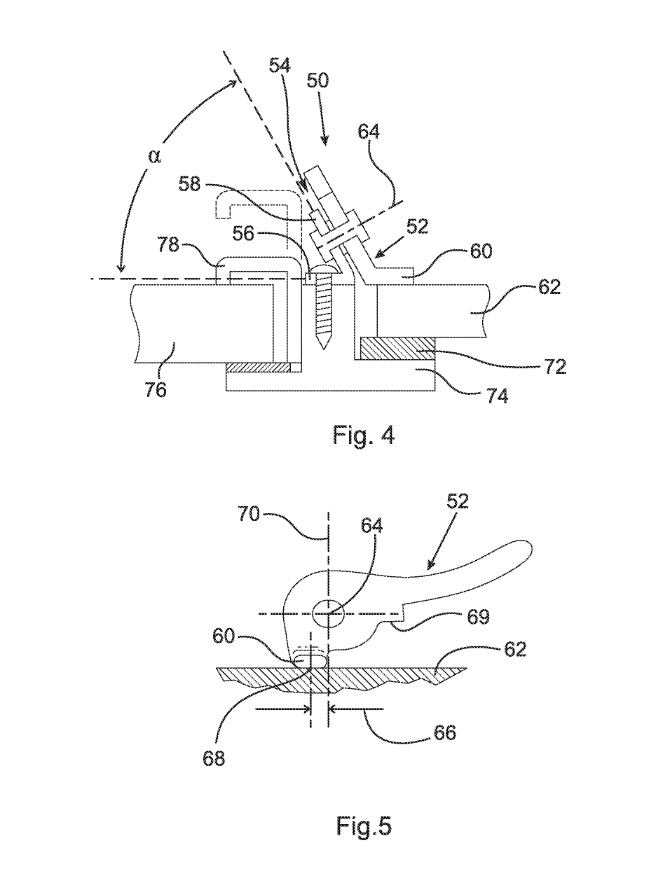

Adverting now to the figures, FIG. 3 shows a perspective view of an embodiment of a present invention camming dog, while FIGS. 4 and 5 show an embodiment of a present invention camming dog in a closed position. Camming dog 50 comprises rotating handle 52 rotationally secured to angled base 54. Angled base 54 comprises base mounting portion 56 and handle mounting portion 58 disposed at an angle relative to each other. It has been found that in preferred embodiments angle α ranges between 60 and 70 degrees depending on size and final geometry of the camming dog. Rotating handle 52 comprises projecting arm boss 60 that reaches out over lens element 62 by some substantial amount so that it is able to press down on lens 62 with enough contact area as to not stress the acrylic and further allows for wide manufacturing tolerances. It has been found that the distance between projecting arm boss 60 and axis of rotation 64, i.e., distance 66, in part controls the performance of the present invention camming dog. As long as contact point 68 of arm boss 60 is slightly offset from axis of rotation 64 of handle 52, and as long as handle 52 comprises rest position/mechanical stop 69, lens 62 cannot open regardless of the forces exerted. Once contact point 68 rotates in a clockwise direction past the perpendicular formed by passing a line through axis of rotation 64 toward lens 62, the force pushing up on arm boss 60 results in handle 52 being pushed in a clockwise rotational direction. Rest position/mechanical stop 69 prevents handle 52 from further clockwise rotation. In other words, arm boss 60 travels past vertical reaction force line 70 of handle pivot pin 71 positioned coaxially with axis of rotation 64 thereby compressing gasket 72 with lens 62, and creating a substantial static opposing force which allows for a “parked” position of handle 52 that precludes the opening of handle 52 due to vibration. It should be appreciated that this arrangement results in lens 62 being held down by the camming action of the geometry of dog 50. The arrangement shown in FIGS. 4 and 5 includes portlight outer frame 74, vessel wall 76 and interior trim ring 78. As one of ordinary skill in the art appreciates, vessel wall 76 may be in a variety of thicknesses depending on such aspects as the vessel design and type of vessel. It has been found that regardless of the thickness of vessel wall 76, camming dog 50 is still free to rotate without interfering with wall 76. For example, if vessel wall 76 is very thick thereby causing trim ring 78 to be elevated, as depicted in broken lines, handle 52 may still rotate through its entire range of motion unimpeded by trim ring 78.

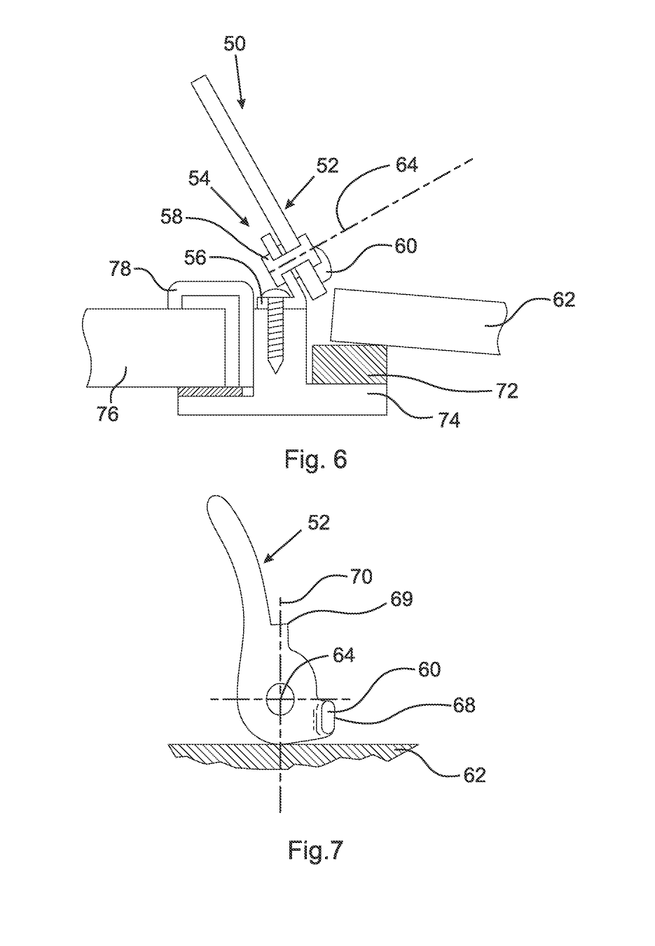

FIGS. 6 and 7 shows handle 52 rotated 90 degrees in the counterclockwise direction. As can be appreciated in view of FIGS. 6 and 7, when handle 52 is rotated 90 degrees in the counterclockwise direction, arm boss 60 has only risen a small amount above its final parked position. In this position, arm boss 60 continues to reach out over lens 62, thereby preventing lens 62 from fully opening. In other words, gasket 72 becomes partially or fully uncompressed while lens 62 remains in a partially open position. It is this arrangement that allows arm boss 60 to engage a partially open lens 62, thereby removing the need for a user to pre-compress lens 62 against gasket 72 in order to actuate and close camming dog 50. It should be noted that all ports which include a gasket rest in a partially open position as shown in FIGS. 6 and 7 due to the height of the uncompressed gasket pushing and holding up the lens. Unlike the known locking dogs, the rotation of handle 52 pushes the resting open lens 62 down against gasket 72 to its final closed position. Thus, the operator of the port does not have to reach up with one hand to close the lens sufficiently to allow the dog mechanism to initially engage the lens. It has been found that the closer arm boss 60 is to axis of rotation 64, i.e., the smaller the value of distance 66, the greater the mechanical force generated to initially engage lens 62 and force it down. In essence, the smaller the width of handle 52 across arm boss 60 and the rotational pin area, the stronger the dog and the greater the downward force generated when the dog is being engaged.

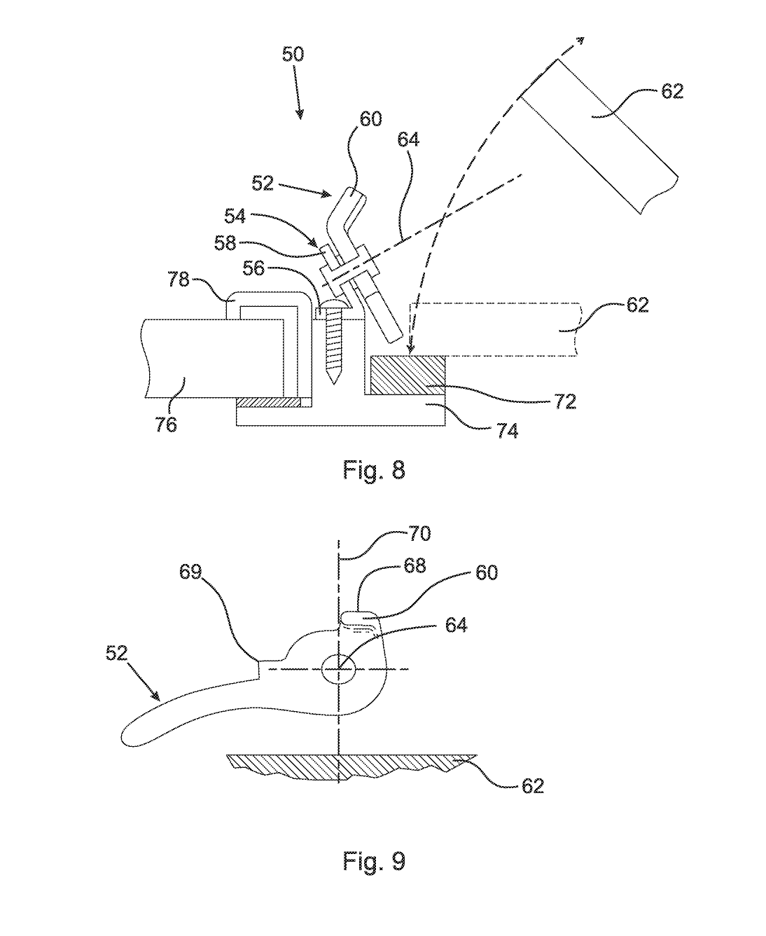

FIGS. 8 and 9 show handle 52 rotated approximately 180 degrees in the counterclockwise direction, i.e., the fully open position. As can be appreciated in view of FIGS. 8 and 9, when handle 52 is in the fully open position, rotation of lens 62 is unimpeded by arm boss 60. It is the arrangement of angled base 54 which permits this to occur, i.e., handle mounting portion 58 extends upwardly and away from lens 62. In other words, by positioning base mounting portion 56 and handle mounting portion 58 at an angle relative to each other, e.g., angle α ranging between 60 and 70 degrees, it has been found that the counterclockwise rotation of handle 52 causes arm boss 60 to be rotated and translated up and away from lens 52 allowing the swinging lens 52 to clear arm boss 60. Meanwhile, the entire handle 52 never moves out of the narrow footprint within which it is positioned. This arrangement permits handle 52 to be smaller in size than other locking dog mechanisms.

In addition to the embodiments set forth above, it has been found that changing the position of the axis of rotation of the handle along the handle mounting portion of the angled base may also be used to control when and how the arm boss engages the lens. For example, shifting the position of the axis of rotation away from the connection between the base mounting portion and the handle mounting portion shifts the boss arm away from the lens thereby providing a similar result as decreasing the angle between the base mounting portion and the handle mounting portion. Such variations are within the spirit and scope of the claimed invention.

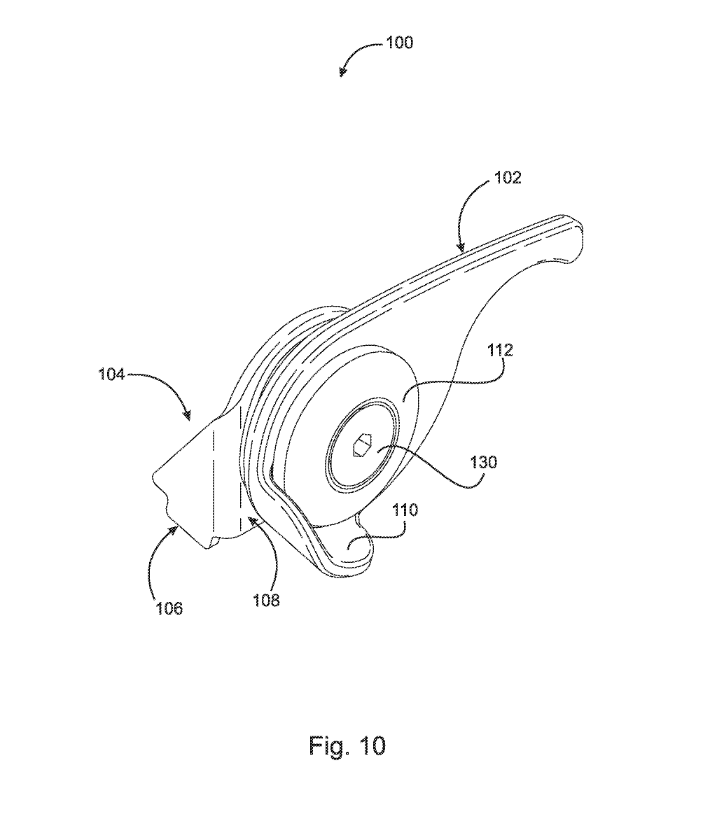

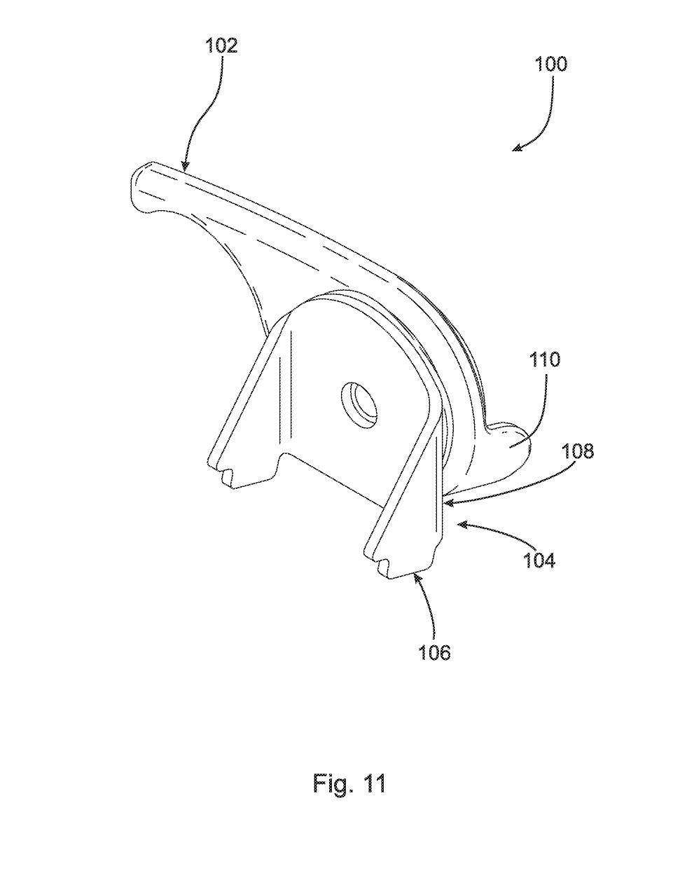

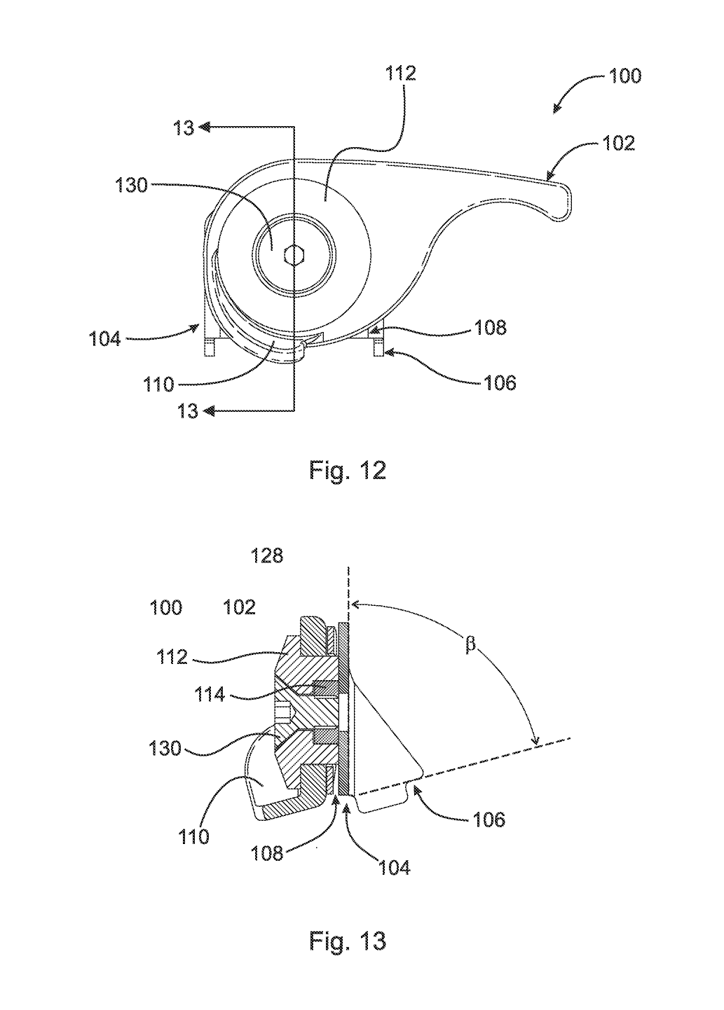

In some embodiments, the camming dog may also include vertical adjustment. In these embodiments, a spacer is mechanically attached to the handle mounting portion and is positioned between the handle mounting portion and the handle. Additionally, a sleeve is included in the handle, positioned off-center from the axis of rotation of the handle. The handle can be made to rise and fall, i.e., vertical adjustment, by rotating the height adjusting spacer element, which results in the pivot point, or axis of rotation, of the handle moving. An example of the foregoing embodiment is depicted in FIGS. 10-14.

Camming dog 100 comprises rotating handle 102 rotationally secured to angled base 104. Angled base 104 comprises base mounting portion 106 and handle mounting portion 108 disposed at an angle relative to each other. It has been found that in preferred embodiments angle β ranges between 60 and 70 degrees depending on size and final geometry of the camming dog. Rotating handle 102 comprises projecting arm boss 110 that reaches out over a lens element (not shown) by some substantial amount so that it is able to press down on the lens with enough contact area as to not stress the acrylic and further allows for wide manufacturing tolerances. Generally, this embodiment functions similarly as the embodiments described above.

The arrangement shown in FIGS. 10 through 14 includes height adjustment sleeve 112 and fixed alignment guide 114. Fixed alignment guide 114 is fixedly secured to handle mounting portion 108 by any means known in the art, e.g., welding, adhesive, etc. Additionally, fixed alignment guide 114 may be integrally formed with handle mounting portion 108, for example by casting or molding angled base 104. Fixed alignment guide 114 provides a keyed arrangement upon which height adjustment sleeve 112 is positioned. Fixed alignment guide 114 may be a hexagonal nut, a spline, or any other suitable means known in the art which prevents rotation of height adjustment sleeve 112 relative to fixed alignment guide 114. Height adjustment sleeve 112 comprises opening 116 which is complimentary to fixed alignment guide 114, i.e., the shape of opening 116 provides complimentary engagement with fixed alignment guide 114 or in other words the shape of opening 116 substantially matches the shape of fixed alignment guide 114.

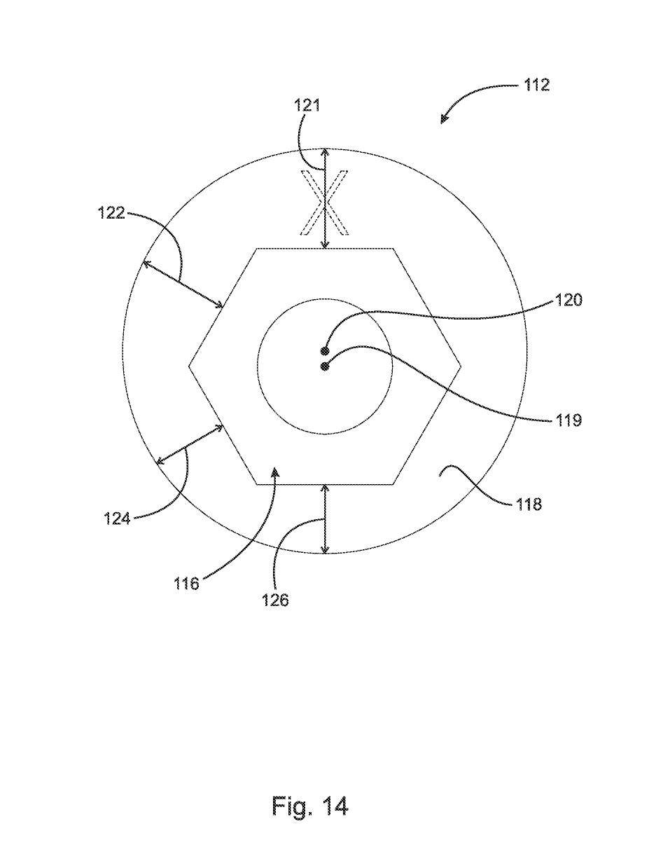

As can be best understood in view of FIG. 14, opening 116 is positioned off center within back portion 118 of sleeve 112, i.e., center 119 of opening 116 does not coincide with center 120 of sleeve 112. In the embodiment shown in FIG. 14, lengths 121, 122, 124 and 126 are each unique, i.e., are each a different length. Thus, based on the rotational orientation of sleeve 112, handle 102 and all its associated elements, e.g., arm boss 110, shift in accordance with bi-directional arrow 128. In short, the position of arm boss 110 relative to base mounting portion 106 can be altered by merely changing the rotational arrangement of sleeve 112 relative to guide 114. The foregoing novel arrangement permits the height of arm boss 110 to be varied to accommodate, for example, manufacturing tolerances or wear to sealing gaskets.

The foregoing arrangement of sleeve 112 and guide 114 further provides the benefit of preventing the unintended rotation of screw 130 relative to guide 114. If sleeve 112 was free to rotate, merely actuating handle 102 would likely cause screw 130 to begin to back out of guide 114. After sufficient use, handle 102 would become loose and require retightening of screw 130 prior to failure of the camming dog. The present invention, having the rotation of sleeve 112 fixed by guide 114, prevents such loosening of screw 130, thereby providing a more consistent and robust closure for a lens.

The present invention provides a locking dog that does not project into the clear viewing area of a portlight. Furthermore, the present invention is attached to a frame of a port and permits the interior trim ring to slide past allowing for various thicknesses of hull or deck structures. The present invention is fast acting and is absolutely positive, self-parking, and cannot vibrate open accidentally while pushing the portlight lens against its sealing gasket. The present invention permits one handed operation thereby avoiding the typical arrangement of the operator pushing against the lens of a portlight to push it down onto the gasket, slightly compressing the gasket, so that the dogging mechanism can engage the lens. Moreover, the present invention is small and compact so as to avoid accidental injury by a person falling against the camming dog, and possesses a self-parking position when the dog is disengaged. Lastly, in some embodiments, the present invention includes vertical adjustment to compensate for permanent gasket compression that occurs over time.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A camming dog configured for use with a window comprising a frame and a hinged lens, the camming dog comprising:
an angled base comprising a base mounting portion and a handle mounting portion, wherein the base mounting portion is secured to the frame, the base mounting portion is disposed at an angle relative to the handle mounting portion, the angle is less than ninety degrees; and,
a handle comprising an arm boss, wherein the handle is rotationally secured to the handle mounting portion of the angled base and rotates about an axis of rotation,
wherein upon rotation of the handle to an open position, the hinged lens rotates unimpeded past the arm boss and upon rotation of the handle to a closed position, the hinged lens is secured within the frame by the arm boss.

2. The camming dog of claim 1 wherein the window is a port for a marine vessel.

3. The camming dog of claim 2 wherein the port is an inwardly opening port and the camming dog is disposed on an inner surface of a wall of the marine vessel.

4. The camming dog of claim 1 wherein the window further comprises a gasket disposed between the frame and the lens, and the lens compressively seals against the gasket when the handle is in the closed position.

5. The camming dog of claim 1 wherein the angle ranges from about 60 to about 70 degrees.

6. The camming dog of claim 1 wherein the handle is rotatably secured to the angled base by a fastener.

7. The camming dog of claim 1 wherein the arm boss contacts the lens at a contact point and the contact point is offset from the axis of rotation.

8. The camming dog of claim 1 wherein the handle further comprises a mechanical stop configured to prevent further rotation of the handle when arranged in the closed position.

9. The camming dog of claim 1 wherein a position of the arm boss relative to the lens is altered by modifying the angle.

10. The camming dog of claim 1 wherein a position of the arm boss relative to the lens is altered by modifying a position of the axis of rotation relative to the handle mounting portion.

11. The camming dog of claim 1 wherein the handle rotates in a plane substantially parallel to the handle mounting portion.

12. The camming dog of claim 1 wherein the handle rotates through approximately one hundred eighty degrees, where the handle is in a closed position at zero degrees, a partially open position at ninety degrees and an open position at one hundred eighty degrees.

13. The camming dog of claim 12 wherein the arm boss is adjacent to the lens when the handle reaches the partially open position as the handle is rotated from the open position to the closed position.

14. The camming dog of claim 12 wherein rotating the handle from the partially open position to the closed position causes the arm boss to engage the lens and subsequently secure the lens within the frame.

15. The camming dog of claim 14 wherein the window further comprises a gasket disposed between the frame and the lens, and rotating the handle from the partially open position to the closed position compresses the lens against the gasket.

16. The camming dog of claim 1 further comprising:
an alignment guide fixedly secured to the handle mounting portion; and,
a height adjustment sleeve comprising an opening offset from a center position on the height adjustment sleeve, the opening complimentarily engaging the alignment guide,
wherein the handle is rotationally secured to the handle mounting portion by the height adjustment sleeve and rotating a position of the height adjustment sleeve relative to the alignment guide alters the position of the handle relative the handle mounting portion.

17. A height adjusting apparatus for a camming dog, wherein the camming dog comprises an angled base comprising a base mounting portion and a handle mounting portion, wherein the base mounting portion is secured to the frame, the base mounting portion is disposed at an angle relative to the handle mounting portion, the angle is less than ninety degrees, and a handle comprising an arm boss, wherein the handle is rotationally secured to the handle mounting portion of the angled base and rotates about an axis of rotation, wherein upon rotation of the handle to an open position, the hinged lens rotates unimpeded past the arm boss and upon rotation of the handle to a closed position, the hinged lens is secured within the frame by the arm boss, the height adjusting apparatus comprising:
an alignment guide fixedly secured to the handle mounting portion; and,
a height adjustment sleeve comprising an opening offset from a center position on the height adjustment sleeve, the opening complimentarily engaging the alignment guide,
wherein the handle is rotationally secured to the handle mounting portion by the height adjustment sleeve and rotating a position of the height adjustment sleeve relative to the alignment guide alters the position of the handle relative the handle mounting portion.
